(19) United States
(12) Patent Application Publication
(10) Pub. No.: US 2017/0255113 A1
(43) Pub. Date: Sep. 7, 2017

(54) IMAGE FORMING APPARATUS AND IMAGE FORMING METHOD

(71) Applicant: FUJI XEROX CO., LTD., Tokyo (JP)

(72) Inventors: Masahiko MIYAMOTO, Kanagawa (JP); Shigeto HASHIBA, Kanagawa (JP)

(73) Assignee: FUJI XEROX CO., LTD., Tokyo (JP)

(21) Appl. No.: 15/230,609

(22) Filed: Aug. 8, 2016

(30) Foreign Application Priority Data
Mar. 2, 2016 (JP) 2016-040245

(51) Int. Cl. G03G 15/00

(52) U.S. Cl. CPC G03G 5/043; G03G 15/75

(57) ABSTRACT

An image forming apparatus includes an electrophotographic photoreceptor that includes a photosensitive layer that contains a charge generation material, a charge transport material, and a binder resin; a charging unit; an electrostatic latent image forming unit; a developing unit; and a transfer unit. A charge amount ΔQ(μC/m²), which is accumulated in the photosensitive layer by exposure conducted by using the electrostatic latent image forming unit, per unit area of a surface of the electrophotographic photoreceptor, a charge potential VH(V) after the surface of the electrophotographic photoreceptor is charged by using the charging unit, and an exposure potential VL(V) of a portion of the surface of the electrophotographic photoreceptor exposed by using the electrostatic latent image forming unit satisfy the following formula: 20(V·m²/μC)≦[VH−VL](V)/ΔQ(μC/m²)≦60(V·m²/μC)

### CROSS-REFERENCE TO RELATED APPLICATIONS

This application is based on and claims priority under 35 USC 119 from Japanese Patent Application No. 2016-040245 filed Mar. 2, 2016.

### BACKGROUND

(i) Technical Field

The present invention relates to an image forming apparatus and an image forming method.

(ii) Related Art

A typical electrophotographic image forming apparatus uses an electrophotographic photoreceptor (hereinafter may be simply referred to as a photoreceptor) to conduct a sequence of steps such as charging, electrostatic latent image formation, development, transfer, and cleaning.

Electrophotographic image forming apparatuses create high-quality images at a high speed and are used as image forming apparatuses such as copy machines, laser beam printers, and LED beam printers.

### SUMMARY

According to an aspect of the invention, there is provided an image forming apparatus that includes an electrophotographic photoreceptor that includes a photosensitive layer that contains a charge generation material, a charge transport material, and a binder resin; a charging unit that charges a surface of the electrophotographic photoreceptor; an electrostatic latent image forming unit that forms an electrostatic latent image by exposing the charged surface of the electrophotographic photoreceptor; a developing unit that develops the electrostatic latent image on the surface of the electrophotographic photoreceptor with a developer that contains a toner so as to form a toner image; and a transfer unit that transfers the toner image onto a surface of a recording medium. A charge amount ΔQ(μC/m²), which is accumulated in the photosensitive layer by exposure conducted by using the electrostatic latent image forming unit, per unit area of the surface of the electrophotographic photoreceptor, a charge potential VH (V) after the surface of the electrophotographic photoreceptor is charged by using the charging unit, and an exposure potential VL (V) of a portion of the surface of the electrophotographic photoreceptor exposed by using the electrostatic latent image forming unit satisfy Formula (1):

20(V·m²/μC)≦[VH−VL](V)/ΔQ(μC/m²)≦60(V·m²/μC) Formula (1)

### BRIEF DESCRIPTION OF THE DRAWINGS

Exemplary embodiments of the present invention will be described in detail based on the following figures, wherein:

FIG. 1 is a graph illustrating a Q-V characteristic of an electrophotographic photoreceptor according to an exemplary embodiment;

FIG. 2 is a schematic cross-sectional view of an exemplary basic structure of an image forming apparatus according to an exemplary embodiment;

FIG. 3 is a schematic diagram illustrating an example of a layer configuration of an electrophotographic photoreceptor according to an exemplary embodiment;

FIG. 4 is a schematic diagram illustrating another example of a layer configuration of an electrophotographic photoreceptor according to an exemplary embodiment; and

FIG. 5 is a schematic diagram illustrating another example of a layer configuration of an electrophotographic photoreceptor according to an exemplary embodiment.

### DETAILED DESCRIPTION

An image forming apparatus according to an exemplary embodiment will now described with reference to the attached drawings. In the drawings, the same or equivalent parts are represented by the same reference symbols and description therefor may be omitted to avoid redundancy.

### Image Forming Apparatus

An image forming apparatus according to this exemplary embodiment includes an electrophotographic photoreceptor that includes a photosensitive layer that contains a charge generation material, a charge transport material, and a binder resin; a charging unit that charges a surface of the electrophotographic photoreceptor; an electrostatic latent image forming unit that forms an electrostatic latent image by exposing the charged surface of the electrophotographic photoreceptor; a developing unit that develops the electrostatic latent image on the surface of the electrophotographic photoreceptor with a developer containing a toner so as to form a toner image; and a transfer unit that transfers the toner image onto a surface of a recording medium. A charge amount ΔQ(μC/m²), which is accumulated in the photosensitive layer by exposure conducted by using the electrostatic latent image forming unit, per unit area of the surface of the electrophotographic photoreceptor (hereinafter this amount may be referred to as an “accumulated charge amount in the photosensitive layer due to light exposure”), a charge potential VH(V) after the surface of the electrophotographic photoreceptor is charged by using the charging unit, and an exposure potential VL(V) of a portion of the surface of the electrophotographic photoreceptor exposed by using the electrostatic latent image forming unit satisfy Formula (1):

20(V·m²/μC)≦[VH−VL](V)/ΔQ(μC/m²)≦60(V·m²/μC) Formula (1)

An image forming apparatus that uses a photoreceptor occasionally causes an image quality defect known as “positive ghosting”. That is, a portion of the photoreceptor surface which has served as an image exposing portion in the previous cycle exhibits a lowered surface potential at the next cycle and thus exhibits a higher density; as a result, the image of the previous cycle thickly appears on the image of the next cycle. Positive ghosting presumably occurs when charges are accumulated in short-lived trapping sites (portions that have a capacity to store charges) excited in the photosensitive layer due to the image exposure in the previous cycle and migrate to the photoreceptor surface from the trapping sites after charging operation of the next cycle, thereby decreasing the surface potential.

In other occasions, an image quality defect known as “negative ghosting” may occur. That is, when a toner image formed on the photoreceptor is being transferred onto a transfer-receiving medium, a voltage having a polarity opposite to that of the photoreceptor surface potential is applied, which significantly decreases the potential of the non-image portion of the previous cycle after transfer; as a result, in the charging step of the next cycle, the portion is not charged to a particular potential, the density of the non-image portion of the previous cycle is increased, and the image portion of the previous cycle vaguely appears (negative ghosting).

The inventors have found that the ghosting is effectively reduced when the accumulated charge amount ΔQ(μC/m²) in the photosensitive layer due to light exposure, the charge potential VH(V) after the surface of the electrophotographic photoreceptor is charged with the charging unit, and the exposure potential VL(V) of a portion of the surface of the electrophotographic photoreceptor exposed by the electrostatic latent image forming unit satisfy the condition set forth in Formula (1) above. The exact reason is not clear but can be assumed as follows.

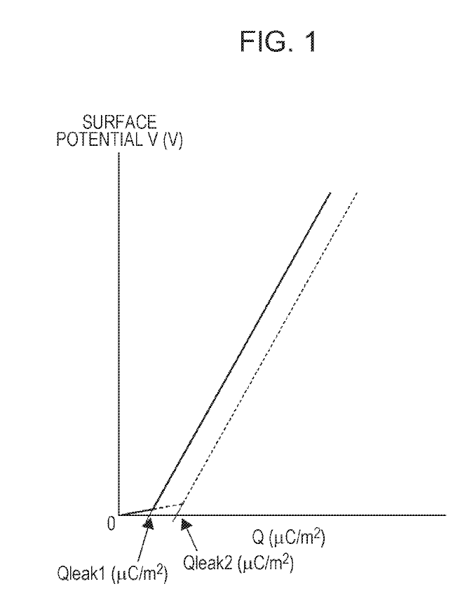

FIG. 1 is a graph illustrating a Q-V characteristic of the electrophotographic photoreceptor. The Q-V characteristic represents the relationship between the charge amount Q and the surface potential V when a charge amount Q(μC/m²) per unit area of the photoreceptor is given and the surface of the photoreceptor is charged to a surface potential V(V). In FIG. 1, the horizontal axis indicates the charge amount Q(μC/m²) per unit area supplied to the photoreceptor surface, and the vertical axis indicates the surface potential V(V) of the photoreceptor to which the charge amount Q(μC/m²) is supplied.

In general, the charging phenomenon of the photoreceptor is ideally the same as the charging phenomenon of a capacitor. Originally, the Q-V characteristic is one dimensional and a linear relationship that passes through the origin 0. However, with an actual photoreceptor, because thermally excited free charges are present in the photosensitive layer and the undercoat layer, charges given to the photoreceptor surface are cancelled out by the thermally excited free charges at an early stage and thus the photoreceptor surface is not charged to Qleak1(μC/m²) marked in FIG. 1. By continuing to give charges to the photoreceptor surface, all thermally excited free charges are consumed and charging of the photoreceptor surface starts.

In this exemplary embodiment, the accumulated charge amount ΔQ(μC/m²) in the photosensitive layer due to light exposure in Formula (1) is obtained as follows.

First, a photoreceptor is loaded onto a device equipped with a charging device, an exposing device, and a charge-erasing device. The Q-V characteristic of the photoreceptor is measured first to obtain a Qleak1(μC/m²) of an initial state. Then a series of steps including charging, exposing, and charge-erasing of the photoreceptor is repeated for 800 cycles. The conditions for repeating 800 cycles are as follows.
Charge potential: 700 (V)
Exposure dose: 10 (mJ/m²)
Exposure wavelength: 780 (nm)
Charge-erasing light source: halogen lamp (product of Hayashi Watch Works Co. Ltd.)
Charge-erasing light wavelength: 600 nm or more and 800 nm or less
Charge-erasing light dose: 30 (mJ/m²)
Speed of rotation: 66.7 (rpm)

After performing 800 cycles of the series of steps, the photoreceptor is left in a dark place for 15 minutes. The Q-V characteristic is again measured under the same conditions as the initial state and Qleak2(μC/m²) after exposure history is obtained. The obtained Qleak1(μC/m²) and Qleak2(μC/m²) are used to calculate ΔQ(μC/m²) by using Formula (2).

ΔQ(μC/m²)=Qleak2(μC/m²)−Qleak1(μC/m²) Formula (2)

In FIG. 1, the solid line indicates the Q-V characteristic of the initial state and the dotted line indicates the Q-V characteristic after a series of steps of charging, exposing, and charge-erasing of the photoreceptor is repeated for 800 cycles and the photoreceptor is left in a dark place for 15 minutes. In FIG. 1, Qleak1(μC/m²) is an intercept to the horizontal axis of the Q-V characteristic at the initial state and Qleak2(μC/m²) is an intercept to the horizontal axis of the Q-V characteristics after 800 cycles. The graph illustrates that Qleak2(μC/m²) has a tendency to be large compared to Qleak1(μC/m²) because repeating 800 cycles of a series of steps of charging, exposing, and charge-erasing excites short-lived trapping sites due to the exposure history in the photosensitive layer and charges accumulate in the trapping sites as a result.

Repeating 800 cycles of a series of steps of charging, exposing, and charge-erasing of the photoreceptor can be regarded to be equivalent to an exposure history formed by continuous exposure of a short cycle number if the actual operation situation up to the end of the lifetime of the photoreceptor in the image forming apparatus is taken into consideration. Thus, an electronic interpretation of ΔQ(μC/m²) is that ΔQ(μC/m²) equals to the amount of charges accumulated in the short-lived trapping sites excited by the exposure history.

In Formula (1), [VH−VL](V)/ΔQ(μC/m²) represents a range of a ratio of the difference in electrostatic latent image potential between an image portion and a non-image portion relative to the amount of charges accumulated in the short-lived trapping sites excited by the exposure history.

When [VH−VL](V)/ΔQ(μC/m²) is large, the amount of charges accumulated in the short-lived trapping sites excited by the exposure history is interpreted as being sufficiently small compared to the difference in electrostatic latent image potential between the image portion and the non-image portion. In other words, when the photoreceptor is used in the image forming apparatus, the amount of charges accumulated in the light-excited short-lived trapping sites in the photosensitive layer of the image exposure portion of the previous cycle is sufficiently small and thus the decrease in photoreceptor surface potential after charging of the next cycle is reduced, resulting in suppression of positive ghosting. If [VH−VL](V)/ΔQ(μC/m²) is larger than 60(V·m²/μC), the influence of the transfer step performed on the non-exposure portion in the previous cycle is increased and negative ghosting is likely to occur.

In contrast, when [VH−VL](V)/ΔQ(μC/m²) is small, the photoreceptor surface potential in the image exposure portion of the previous cycle decreases significantly after charging of the next cycle and positive ghosting is likely to occur. However, the photoreceptor used in the image forming apparatus is under transfer stress having a polarity opposite to that of the surface potential in the transfer step and thus negative ghosting occurs. By allowing an appropriate degree of positive ghosting to occur, negative ghosting is cancelled out by positive ghosting, and presumably an output image with less positive ghosting and negative ghosting is obtained as a result. If [VH−VL](V)/ΔQ(μC/m²) is less than 20(V·m²μC), ΔQ(μC/m²) is large for [VH−VL](V). Thus, the surface potential of the exposed portion of the previous cycle significantly decreases after charging of the next cycle and positive ghosting is likely to occur.

In order to control [VH−VL](V)/ΔQ(μC/m²) in Formula (1), for example, when the photoreceptor includes a separated-function-type photosensitive layer constituted by a charge generation layer and a charge transport layer, it is effective to adjust the thickness of the charge generation layer. The short-lived trapping sites excited by the exposure history are mainly formed in the charge generation layer. Thus, if the thickness of the charge generation layer is large, the amount of charges accumulated in the trapping sites, i.e., ΔQ(μC/m²), is increased. If [VH−VL](V) is constant, [VH−VL](V)/ΔQ(μC/m²) is decreased. In contrast, if the thickness of the charge generation layer is small, ΔQ(μC/m²) is decreased. If [VH−VL](V) is constant, then [VH−VL](V)/ΔQ(μC/m²) is increased.

If the thickness of the charge generation layer is constant, [VH−VL](V)/ΔQ(μC/m²) can be controlled by changing [VH−VL](V).

Adding a hindered phenol antioxidant to the photosensitive layer or the charge transport layer presumably has an effect of eliminating the trapping sites. This is probably due to the interaction, such as charge exchange, between the antioxidant and the short-lived trapping sites excited by the exposure history. Thus, ΔQ(μC/m²) as well as [VH−VL](V)/ΔQ(μC/m²) can be controlled by adjusting the hindered phenol antioxidant content.

If [VH−VL](V)/ΔQ(μC/m²) can be controlled within the range that satisfies Formula (1), any other method may be employed to effectively suppress occurrence of positive ghosting and negative ghosting.

In order to suppress occurrence of positive ghosting and negative ghosting and to obtain satisfactory output images, [VH−VL](V)/ΔQ (μC/m²) may be 20(V·m²/μC) or more and 60(V·m²/μC) or less, may be 25(V·m²/μC) or more and 55(V·m²/μC) or less, or may be 35(V·m²/μC) or more and 50(V·m²/μC) or less.

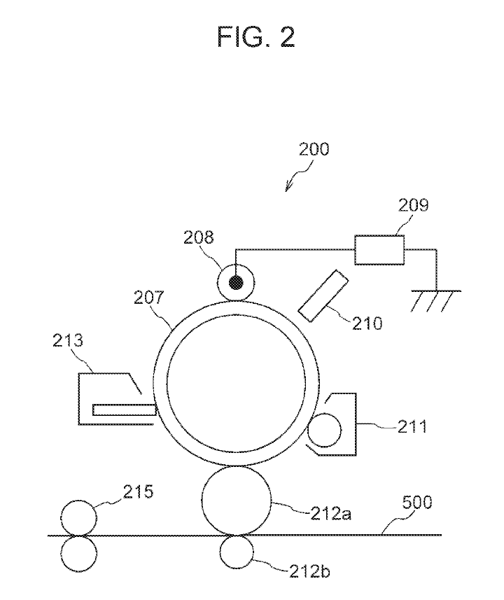

FIG. 2 is a schematic cross-sectional view of an exemplary basic structure of the image forming apparatus according to an exemplary embodiment. An image forming apparatus 200 in FIG. 2 includes an electrophotographic photoreceptor 207, a contact-type charging device 208 (an example of the charging unit) that charges the electrophotographic photoreceptor 207, a power supply 209 connected to the contact-type charging device 208, an exposing device 210 (an example of an electrostatic latent image forming unit) that forms an electrostatic latent image by exposing the electrophotographic photoreceptor 207 charged by the contact-type charging device 208, a developing device 211 (an example of the developing unit) that forms a toner image by developing the electrostatic latent image, which has been formed by the exposing device 210, with a toner, a first transfer device 212a (an example of the transfer unit) that conducts first transfer of the toner image formed by the developing device 211, a second transfer device 212b (an example of the transfer unit) that conducts second transfer of the toner image from the first transfer device 212a onto a recording sheet 500 (an example of the recording medium), a cleaning device 213 (an example of the cleaning unit), and a fixing device 215 (an example of the fixing unit).

### Electrophotographic Photoreceptor

The electrophotographic photoreceptor includes a photosensitive layer that contains a charge generation material, a charge transport material, and a binder resin.

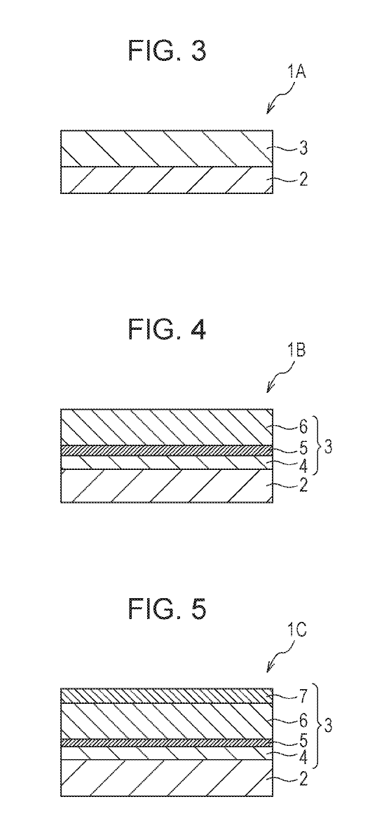

FIGS. 3 to 5 are each a schematic view of a structure of the electrophotographic photoreceptor used in this exemplary embodiment. A cross-section of the electrophotographic photoreceptor taken along a plane perpendicular to the stacking direction of a conductive substrate 2 and the photosensitive layer is illustrated.

An electrophotographic photoreceptor 1A illustrated in FIG. 3 includes a photosensitive layer 3 on the conductive substrate 2. The electrophotographic photoreceptor 1A is a single-layer electrophotographic photoreceptor in which the photosensitive layer 3 is formed of a single layer that contains both a charge generation material and a charge transport material.

In contrast, electrophotographic photoreceptors 1B and 1C illustrated in FIGS. 4 and 5 are each a separated-function-type photoreceptor. The photosensitive layer 3 of each of the electrophotographic photoreceptors 1B and 1C includes a charge generation layer 5 and a charge transport layer 6 separately. To be more specific, in the electrophotographic photoreceptor 1B illustrated in FIG. 4, an undercoat layer 4, a charge generation layer 5, and a charge transport layer 6 are stacked on the conductive substrate 2 in this order to constitute the photosensitive layer 3. In the electrophotographic photoreceptor 1C illustrated in FIG. 5, an undercoat layer 4, a charge generation layer 5, a charge transport layer 6, and a protective layer 7 are stacked on the conductive substrate 2 in this order to constitute the photosensitive layer 3.

The undercoat layer and the protective layer are optional layers. An intermediate layer may be disposed between an undercoat layer and a photosensitive layer or between an undercoat layer and a charge generation layer.

In the description below, a separated-function-type photoreceptor is specifically described as an example of the electrophotographic photoreceptor used in this exemplary embodiment. The reference numerals are omitted in the description below.

### Conductive Substrate

Examples of the conductive substrate include metal plates, metal drums, and metal belts that contain metals (aluminum, copper, zinc, chromium, nickel, molybdenum, vanadium, indium, gold, platinum, etc.) or alloys (stainless steels etc.). Other examples of the conductive substrate include paper, resin films, and belts covered with a conductive compound (for example, conductive polymer or indium oxide), a metal (for example, aluminum, palladium, or gold), or an alloy by coating, vapor-deposition or lamination. The term “conductive” means that the volume resistivity is less than 10¹³ Ωcm.

When the electrophotographic photoreceptor is used in a laser printer, the surface of the conductive substrate may be roughened so that the center-line average roughness Ra is 0.04 μm or more and 0.5 μm or less. This is to decrease interference fringes that occur during irradiation with a laser beam. When incoherent light is used as a light source, the surface roughening for preventing interference fringes is optional. However, surface roughening decreases occurrence of defects caused by irregularities on the surface of the conductive substrate and extends the service life.

Examples of the surface roughening technique include wet honing that involves spraying a suspension of an abrasive in water onto a support member, centerless grinding that involves pressing a conductive substrate against a rotating grinding stone to continuously perform grinding, and anodization.

Another example of the surface roughening technique does not involve directly roughening a surface of a conductive substrate; instead, the technique involves forming a layer on the surface of the conductive substrate by using a dispersion containing dispersed conductive or semi-conductive powder in a resin so that the rough surface is created by the particles dispersed in that layer.

The surface roughening by anodization involves anodizing a metal (for example, aluminum) conductive substrate serving as an anode in an electrolyte solution so as to form an oxide film on the surface of the conductive substrate. Examples of the electrolyte solution include a sulfuric acid solution and an oxalic acid solution. However, a porous anodic oxide film as is formed by anodization is chemically active and susceptible to contamination and undergoes large changes in resistance depending on the environment. Thus, the porous anodic oxide film may be subjected to a pore sealing treatment in which the fine pores of the oxide film are stopped by volume expansion caused by hydration reaction in pressurized water vapor or in boiling water (a metal salt such as a nickel salt may be added) so that the oxide is transformed into a more stable hydrous oxide.

The thickness of the anodic oxide film may be, for example, 0.3 μm or more and 15 μm or less. When the thickness is within this range, a barrier property tends to be exhibited against injection and the increase in residual potential caused by repeated use tends to be suppressed.

The conductive substrate may be treated with an acidic treatment solution or be subjected to a Boehmite treatment.

The treatment with an acidic treatment solution may be carried out as follows, for example. First, an acidic treatment solution containing phosphoric acid, chromic acid, and hydrofluoric acid is prepared. The blend ratios of the phosphoric acid, chromic acid, and hydrofluoric acid in the acidic treatment solution are, for example, phosphoric acid: 10% by weight or more and 11% by weight or less, chromic acid: 3% by weight or more and 5% by weight or less, hydrofluoric acid: 0.5% by weight or more and 2% by weight or less. The total concentration of all the acids may be in the range of 13.5% by weight or more and 18% by weight or less. The treatment temperature may be, for example, 42° C. or higher and 48° C. or lower. The thickness of the film may be 0.3 μm or more and 15 μm or less.

The Boehmite treatment is carried out by immersing the substrate in pure water at 90° C. or higher and 100° C. or lower for 5 to 60 minutes or by bringing the base in contact with heated water vapor at 90° C. or higher and 120° C. or lower for 5 to 60 minutes. The thickness of the film may be 0.1 μm or more and 5 μm or less. The treated base may be further subjected to an anodization treatment by using an electrolyte solution having a low film-dissolving property. Examples of the electrolyte here include adipic acid, boric acid, a borate, a phosphate, a phthalate, a maleate, a benzoate, a tartrate, and a citrate.

### Undercoat Layer

The undercoat layer is, for example, a layer that contains inorganic particles and a binder resin.

Examples of the inorganic particles include those having powder resistance (volume resistivity) of 10² Ωcm or more and 10¹¹ Ωcm or less. Examples of the inorganic particles having such a resistivity include metal oxide particles such as tin oxide particles, titanium oxide particles, zinc oxide particles, and zirconium oxide particles. In particular, zinc oxide particles may be used.

The BET specific surface area of the inorganic particles measured may be, for example, 10 m²/g or more. The volume-average particle diameter of the inorganic particles may be, for example, 50 nm or more and 2000 nm or less (or may be 60 nm or more and 1000 nm or less).

The amount of the inorganic particles relative to the binder resin is, for example, 10% by weight or more and 80% by weight or less, and may be 40% by weight or more and 80% by weight or less.

The inorganic particles may be surface-treated. Two or more types of inorganic particles subjected to different surface treatments or having different particle diameters may be mixed and used.

Examples of the surface treatment agent include silane coupling agents, titanate-based coupling agents, aluminum-based coupling agents, and surfactants. Silane coupling agents are preferable, and amino-group-containing silane coupling agents are more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be used as a mixture. For example, an amino-group-containing silane coupling agent and another silane coupling agent may be used in combination. Examples of the this another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using a surface treatment agent may be any known method and may be a dry or wet method.

The amount of the surface treatment agent used in the treatment may be 0.5% by weight or more and 10% by weight or less relative to the inorganic particles.

The undercoat layer may contain inorganic particles and an electron-accepting compound (acceptor compound) from the viewpoints of enhancing long-term stability of electrical characteristics and a carrier blocking property.

Examples of the electron-accepting compound include electron transport substances. Examples thereof include quinone-based compounds such as chloranil and bromanil; tetracyanoquinodimethane-based compounds; fluorenone compounds such as 2,4,7-trinitrofluorenone and 2,4,5,7-tetranitro-9-fluorenone; oxadiazole-based compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone-based compounds; thiophene compounds; and diphenoquinone compounds such as 3,3′,5,5′-tetra-t-butyldiphenoquinone.

A compound having an anthraquinone structure may be used as the electron-accepting compound. Examples of the compound having an anthraquinone structure include hydroxyanthraquinone compounds, aminoanthraquinone compounds, and aminohydroxyanthraquinone compounds. Specific examples thereof include anthraquinone, alizarin, quinizarin, anthrarufin, and purpurin.

The electron-accepting compound may be contained in the undercoat layer by being co-dispersed with the inorganic particles or by being attached to the surfaces of the inorganic particles.

Examples of the method for attaching the electron-accepting compound onto the surfaces of the inorganic particles include a wet method or a dry method.

According to a dry method, for example, while inorganic particles are being stirred with a mixer having large shear force, an electron-accepting compound as is or as dissolved in an organic solvent is added thereto dropwise or sprayed along with dry air or nitrogen gas so that the electron-accepting compound attaches to the surfaces of the inorganic particles. Dropwise addition or spraying of the electron-accepting compound may be performed at a temperature not higher than the boiling point of the solvent. After dropwise addition or spraying of the electron-accepting compound, baking may be conducted at 100° C. or higher. Baking may be performed at any temperature for any length of time as long as electrophotographic properties are obtained.

According to a wet method, for example, while inorganic particles are being dispersed in a solvent by stirring or by using ultrasonic waves, a sand mill, an attritor, a ball mill, or the like, an electron-accepting compound is added thereto, and after stirring or dispersing, the solvent is removed to have the electron-accepting compound attach to the surfaces of the inorganic particles. Examples of the method for removing the solvent include filtration and distillation. Baking at 100° C. or higher may be conducted after the removal of the solvent. Baking may be performed at any temperature for any length of time as long as electrophotographic properties are obtained. In the wet method, water contained in the inorganic particles may be removed prior to adding the electron-accepting compound. For example, the inorganic particles may be stirred and heated in a solvent to remove water or water may be azeotropically removed with a solvent.

Attaching the electron-accepting compound may be performed before, after, or simultaneously with performing the surface treatment on the inorganic particles by using a surface treatment agent.

The amount of the electron-accepting compound relative to the inorganic particles is, for example, 0.01% by weight or more and 20% by weight or less and may be 0.01% by weight or more and 10% by weight or less.

Examples of the binder resin used in the undercoat layer include known polymer materials such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; and other known materials such as zirconium chelate compounds, titanium chelate compounds, aluminum chelate compounds, titanium alkoxide compounds, organic titanium compounds, and silane coupling agents. Other examples of the binder resin used in the undercoat layer include charge transport resins having charge transport groups and conductive resins (for example, polyaniline).

Among these, a resin insoluble in the coating solvent contained in the overlying layer may be used as the binder resin contained in the undercoat layer. Examples thereof include thermosetting resins such as urea resins, phenolic resins, phenol-formaldehyde resins, melamine resins, urethane resins, unsaturated polyester resins, alkyd resins, and epoxy resins; and resins obtained by reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin. When two or more of these binder resins are used in combination, the mixing ratio is set as desired.

The undercoat layer may contain various additives that improve electrical properties, environmental stability, and image quality. Examples of the additives include known materials such as electron transport pigments based on fused polycyclic and azo materials, zirconium chelate compounds, titanium chelate compounds, aluminum chelate compounds, titanium alkoxide compounds, organic titanium compounds, and silane coupling agents. Although a silane coupling agent is used in a surface treatment of inorganic particles as discussed above, it may also be added to the undercoat layer as an additive.

Examples of the silane coupling agent used as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compound include zirconium butoxide, zirconium ethyl acetoacetate, zirconium triethanolamine, zirconium acetylacetonate butoxide, zirconium ethyl acetoacetate butoxide, zirconium acetate, zirconium oxalate, zirconium lactate, zirconium phosphonate, zirconium octanoate, zirconium naphthenate, zirconium laurate, zirconium stearate, zirconium isostearate, zirconium methacrylate butoxide, zirconium stearate butoxide, and zirconium isostearate butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octyleneglycolate, titanium lactate ammonium salt, titanium lactate, titanium lactate ethyl ester, titanium triethanolaminate, and polyhydroxytitanium stearate.

Examples of the aluminum chelate compounds include aluminum isopropylate, monobutoxyaluminum diisopropylate, aluminum butyrate, diethylacetoacetate aluminum diisopropylate, and aluminum tris(ethyl acetoacetate).

These additives may be used alone, as a mixture of two or more compounds, or as a polycondensation product of two or more compounds.

The undercoat layer may have a Vickers hardness of 35 or more. In order to suppress Moire-images, the surface roughness (ten point average roughness) of the undercoat layer may be adjusted to be in the range of 1/(4n) (n represents a refractive index of the overlying layer) to (½) of the wavelength λ of the laser used for exposure.

Resin particles and the like may be added to the undercoat layer to adjust the surface roughness. Examples of the resin particles include silicone resin particles, and crosslinked polymethyl methacrylate resin particles. The surface of the undercoat layer may be polished to adjust the surface roughness. Examples of the polishing technique include buff polishing, sand blasting, wet honing, and grinding.

The undercoat layer may be formed by any known method. For example, a coating solution for forming an undercoat layer may be prepared by adding the above-described components to a solvent and applied to form a coating film, and the coating film may be dried, and if desirable, heated.

A known organic solvent may be used as the solvent for preparing the coating solution for forming the undercoat layer. Examples of the known organic solvent include alcohol-based solvents, aromatic hydrocarbon solvents, halogenated hydrocarbon solvents, ketone-based solvents, ketone alcohol-based solvents, ether-based solvents, and ester-based solvents.

Specific examples of these solvents include methanol, ethanol, n-propanol, isopropanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the technique for dispersing inorganic particles in preparing the coating solution for forming the undercoat layer include known techniques that use a roll mill, a ball mill, a vibrating ball mill, an attritor, a sand mill, a colloid mill, and a paint shaker.

Examples of the technique for applying the coating solution for forming the undercoat layer onto the conductive substrate include known techniques such as a blade coating technique, a wire bar coating technique, a spray coating technique, a dip coating technique, a bead coating technique, an air knife coating technique, and a curtain coating technique.

The thickness of the undercoat layer is, for example, 15 μm or more and may be in the range of 20 μm or more and 50 μm or less.

### Intermediate Layer

An intermediate layer may be further provided between the undercoat layer and the photosensitive layer although this is not illustrated in the drawings. The intermediate layer is, for example, a layer containing a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer that contains an organic metal compound. Examples of the organic metal compound used in the intermediate layer include those which contain metal atoms such as zirconium, titanium, aluminum, manganese, and silicon atoms. The compounds used in the intermediate layer may be used alone, as a mixture of two or more compounds, or as a polycondensation product of two or more compounds.

In particular, the intermediate layer may be a layer that contains an organic metal compound that contains a zirconium atom or a silicon atom.

The intermediate layer may be formed by any known method. For example, a coating solution for forming the intermediate layer may be prepared by adding the above-described components to a solvent and applied to form a coating film, and the coating film may be dried and, if desired, heated. Examples of the technique for applying the solution for forming the intermediate layer include known techniques such as a dip coating technique, a lift coating technique, a wire bar coating technique, a spray coating technique, a blade coating technique, a knife coating technique, and a curtain coating technique.

The thickness of the intermediate layer may be set within the range of 0.1 μm or more and 3 μm or less. The intermediate layer may also serve as an undercoat layer.

### Charge Generation Layer

The charge generation layer 5 contains a binder resin and a charge generation material. Any known charge generation material can be used as the charge generation material. The charge generation material may be a phthalocyanine pigment. The phthalocyanine pigment may be hydroxygallium phthalocyanine, which has a high charge generation efficiency.

When the photosensitive layer of the photoreceptor contains, as a charge generation material, hydroxygallium phthalocyanine, occurrence of positive ghosting and negative ghosting is more effectively prevented. The reason why the photoreceptor that includes the photosensitive layer containing hydroxygallium phthalocyanine as a charge generation material more effectively prevents occurrence of positive ghosting and negative ghosting is the high charge generation efficiency of hydroxygallium phthalocyanine. Due to the high charge generation efficiency of hydroxygallium phthalocyanine, the accumulated charge amount of the previous cycle is increased, more charges migrate to the photoreceptor surface after charging of the next cycle, and thus the surface potential is smoothly decreased. Moreover, in the transfer step, when voltage having a polarity opposite to that of the photoreceptor surface potential is applied, charges having the opposite polarity easily accumulate in the photosensitive layer and thus presumably the surface potential of the non-image portion of the previous cycle is easily decreased.

The charge generation material is dispersed in the binder resin to constitute the charge generation layer 5.

The binder resin may be selected from a wide variety of insulating resins. Examples of the binder resins include insulating resins such as polyvinyl acetal resins, polyarylate resins, polycarbonate resins, polyester resins, phenoxy resins, vinyl chloride-vinyl acetate copolymers, polyamide resins, acrylic resins, polyacrylamide resins, polyvinylpyridine resins, cellulose resins, urethane resins, epoxy resins, casein, polyvinyl alcohol resins, and polyvinyl pyrrolidone resins; and organic photoconductive polymers such as poly-N-vinylcarbazole, polyvinyl anthracene, polyvinyl pyrene, and polysilane. Among these, a polyvinyl acetal resin or a vinyl chloride-vinyl acetate copolymer may be used. These binder resins may be used alone or in combination.

The mixing ratio (weight ratio) of the charge generation material to the binder resin may be in the range of 10:1 to 1:10 or may be in the range of 8:2 to 3:7.

In forming the charge generation layer 5, a coating solution prepared by dispersing the charge generation material in a solution prepared by dissolving the binder resin in an organic solvent is used. Examples of the organic solvent used to prepare the coating solution for forming a charge generation layer include organic solvents that can dissolve the binder resin. Examples thereof include alcohol solvents, aromatic solvents, halogenated hydrocarbon solvents, ketone solvents, ketone alcohol solvents, ether solvents, and ester solvents. More specific examples include methanol, ethanol, n-propanol, isopropanol, n-butanol, benzyl alcohol, methylcellosolve, ethylcellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene. These solvents may be used alone or in combination.

Examples of the method for dispersing the charge generation material in the binder resin solution include the methods that use a ball mill, a roll mill, a sand mill, an attritor, or ultrasonic waves.

Examples of the method for coating the undercoat layer (or intermediate layer) with the coating solution for forming a charge generation layer include common methods such as a blade coating method, a wire bar coating method, a spray coating method, a dip coating method, a bead coating method, an air knife coating method, and a curtain coating method.

The thickness of the charge generation layer is set in the range of, for example, from 0.1 μm or more to 0.27 μm or less or may be 0.1 μm or more and 0.25 μm or less.

### Charge Transport Layer

The charge transport layer 6 contains a binder resin and a charge transport material. Any known charge transport material can be used as the charge transport material. For example, a compound represented by Formula (CT1) below and a compound represented by Formula (CT2) below may be used.

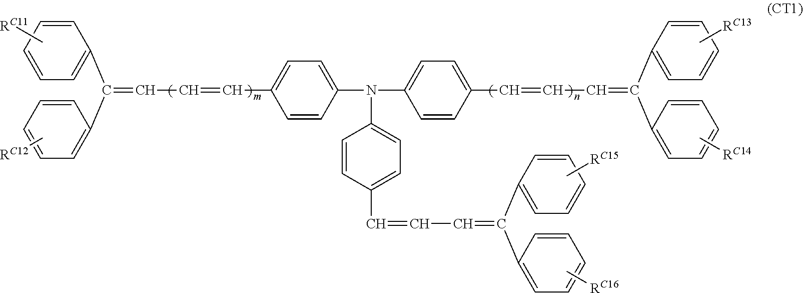

In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms. Adjacent two substituents may bond to each other to form a hydrocarbon ring structure. In the formula, n and m each independently represent 0, 1, or 2.

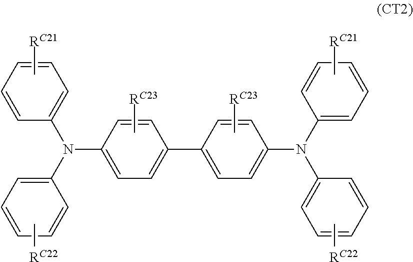

In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

When the photoreceptor includes a charge transport layer that contains, as the charge transport material, a compound represented by Formula (CT1) and a compound represented by Formula (CT2), positive ghosting and negative ghosting are more effectively suppressed. The reason why positive ghosting and negative ghosting are more effectively suppressed when the photoreceptor includes a charge transport layer that contains, as the charge transport material, a compound represented by Formula (CT1) and a compound represented by Formula (CT2) is presumably as follows. Because the compound represented by Formula (CT1) and the compound represented by Formula (CT2) have high charge moving abilities (high charge mobility), accumulated charges in the previous cycle quickly migrate to the photoreceptor surface after charging of the next cycle and the surface potential of the image portion of the previous cycle is smoothly decreased. Moreover, when a voltage having a polarity opposite to that of the photoreceptor surface potential is applied in the transfer step, the charges having the opposite polarity easily accumulate in the photosensitive layer and thus the surface potential of the non-image portion of the previous cycle is easily decreased.

Examples of the halogen atom represented by R^{C11}, R^{C12}, R^{C13}, R^{C14}, R^{C15}, and R^{C16} in Formula (CT1) include a fluorine atom, a chlorine atom, a bromine atom, and an iodine atom. The halogen atom is preferably a fluorine atom or a chlorine atom, and more preferably a chlorine atom.

Examples of the alkyl group represented by R^{C11}, R^{C12}, R^{C13}, R^{C14}, R^{C15}, and R^{C16} in Formula (CT1) include linear or branched alkyl groups having from 1 to 20 carbon atoms (preferably from 1 to 6 carbon atoms and more preferably from 1 to 4 carbon atoms).

Specific examples of the linear alkyl groups include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group.

Specific examples of the branched alkyl groups include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, an tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoicosyl group, a sec-icosyl group, a tert-icosyl group, and a neoicosyl group.

Among these, the alkyl group is preferably a lower alkyl group such as a methyl group, an ethyl group, or an isopropyl group.

Examples of the alkoxy group represented by R^{C11}, R^{C12}, R¹³, R¹⁴, R¹⁵, and R¹⁶ in Formula (CT1) include linear or branched alkoxy groups having from 1 to 20 carbon atoms (preferably from 1 to 6 carbon atoms and more preferably from 1 to 4 carbon atoms).

Specific examples of the linear alkoxy groups include a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, and an n-icosyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group, a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, a 1-methyloctyloxy group, an isoicosyloxy group, a sec-icosyloxy group, a tert-icosyloxy group, and a neoicosyloxy group.

Among these, a methoxy group is preferable as the alkoxy group.

Examples of the aryl group represented by R^{C11}, R¹², R^{C13}, R^{C14}, R^{C15}, and R^{C16} in Formula (CT1) include aryl groups having from 6 to 30 carbon atoms (preferably from 6 to 20 carbon atoms and more preferably from 6 to 16 carbon atoms).

Specific examples of the aryl group include a phenyl group, a naphthyl group, a phenanthryl group, and a biphenyl group. Among these, a phenyl group and a naphthyl group are preferable as the aryl group.

The substituents represented by R^{C11}, R^{C12}, R^{C13}, R^{C14}, R^{C15}, and R^{C16} in Formula (CT1) include those that have substituents. Examples of these substituents include atoms and groups (for example, a halogen atom, an alkyl group, an alkoxy group, an aryl group, etc.) described as examples above.

When adjacent two substituents selected from R^{C11}, R^{C12}, R^{C13}, R^{C14}, R^{C15}, and R^{C16} in Formula (CT1) are linked to each other (for example, R^{C11} and R^{C12}, R^{C13} and R^{C14}, and R^{C15} and R^{C16}) to form a hydrocarbon ring structure, examples of the linking group that links those substituents include a single bond, a 2,2′-methylene group, a 2,2′-ethylene group, and a 2,2′-vinylene group. The linking group may be a single bond or a 2,2′-methylene group.

Specific examples of the hydrocarbon ring structure include a cycloalkane structure, a cycloalkene structure, and a cycloalkane polyene structure.

In Formula (CT1), n and m may each be 1.

In order to form a photosensitive layer (charge transport layer) having a high charge transport capacity, R^{C11}, R^{C12}, R^{C13}, R^{C14}, R^{C15}, and R^{C16} in Formula (CT1) may each independently represent a hydrogen atom, an alkyl group having from 1 to 20 carbon atoms, or an alkoxy group having from 1 to 20 carbon atoms and m and n may each independently represent 1 or 2. More preferably, R^{C11}, R^{C12}, R¹³, R^{C14}, R^{C15}, and R^{C16} each independently represent a hydrogen atom and m and n each represent 1.

In other words, the compound (CT1) represented by Formula (CT1) may be a charge transport material (Example Compound (CT1-3)) represented by Formula (CT1A) below:

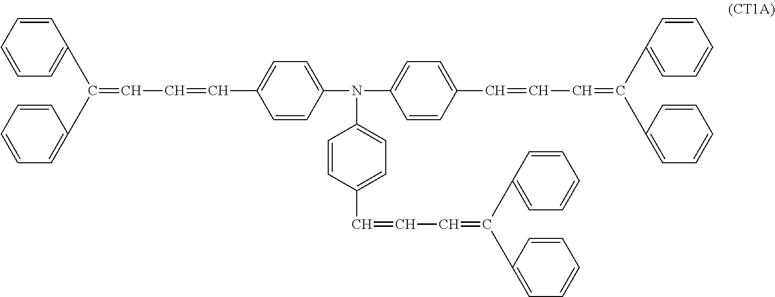 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Non-limiting specific examples of the compound represented by Formula (CT1) are as follows.

### [Chem. 8]

| Example | | | | | | | | |
|---|---|---|---|---|---|---|---|---|
| compound No. | m | n | R^{C11} | R^{C12} | R^{C13} | R^{C14} | R^{C15} | R^{C16} |
| CT1-1 | 1 | 1 | 4—CH₃ | 4—CH₃ | 4—CH₃ | 4—CH₃ | H | H |
| CT1-2 | 2 | 2 | H | H | H | H | 4—CH₃ | 4—CH₃ |
| CT1-3 | 1 | 1 | H | H | H | H | H | H |
| CT1-4 | 2 | 2 | H | H | H | H | H | H |
| CT1-5 | 1 | 1 | 4—CH₃ | 4—CH₃ | 4—CH₃ | H | H | H |
| CT1-6 | 0 | 1 | H | H | H | H | H | H |
| CT1-7 | 0 | 1 | 4—CH₃ | 4—CH₃ | 4—CH₃ | 4—CH₃ | 4—CH₃ | 4—CH₃ |
| CT1-8 | 0 | 1 | 4—CH₃ | 4—CH₃ | H | H | 4—CH₃ | 4—CH₃ |
| CT1-9 | 0 | 1 | H | H | 4—CH₃ | 4—CH₃ | H | H |
| CT1-10 | 0 | 1 | H | H | 3—CH₃ | 3—CH₃ | H | H |
| CT1-11 | 0 | 1 | 4—CH₃ | H | H | H | 4—CH₃ | H |
| CT1-12 | 0 | 1 | 4—OCH₃ | H | H | H | 4—OCH₃ | H |
| CT1-13 | 0 | 1 | H | H | 4—OCH₃ | 4—OCH₃ | H | H |
| CT1-14 | 0 | 1 | 4—OCH₃ | H | 4—OCH₃ | H | 4—OCH₃ | 4—OCH₃ |
| CT1-15 | 0 | 1 | 3—CH₃ | H | 3—CH₃ | H | 3—CH₃ | H |
| CT1-16 | 1 | 1 | 4—CH₃ | 4—CH₃ | 4—CH₃ | 4—CH₃ | 4—CH₃ | 4—CH₃ |
| CT1-17 | 1 | 1 | 4—CH₃ | 4—CH₃ | H | H | 4—CH₃ | 4—CH₃ |
| CT1-18 | 1 | 1 | H | H | 4—CH₃ | 4—CH₃ | H | H |
| CT1-19 | 1 | 1 | H | H | 3—CH₃ | 3—CH₃ | H | H |
| CT1-20 | 1 | 1 | 4—CH₃ | H | H | H | 4—CH₃ | H |
| CT1-21 | 1 | 1 | 4—OCH₃ | H | H | H | 4—OCH₃ | H |
| CT1-22 | 1 | 1 | H | H | 4—OCH₃ | 4—OCH₃ | H | H |
| CT1-23 | 1 | 1 | 4—OCH₃ | H | 4—OCH₃ | H | 4—OCH₃ | 4—OCH₃ |
| CT1-24 | 1 | 1 | 3—CH₃ | H | 3—CH₃ | H | 3—CH₃ | H |

Abbreviations for the Examples Compounds are as follows and the number preceding a substituent indicates the substitution site with respect to a benzene ring:
—CH₃: methyl group
—OCH₃: methoxy group

The compounds (CT1) represented by Formula (CT1) may be used alone or in combination.

The charge transport material represented by Formula (CT2) will now be described.

Examples of the halogen atom represented by R^{C21}, R^{C22}, and R^{C23} in Formula (CT2) include a fluorine atom, a chlorine atom, a bromine atom, and an iodine atom. The halogen atom is preferably a fluorine atom or a chlorine atom, and more preferably a chlorine atom.

Examples of the alkyl group represented by R^{C21}, R^{C22}, and R^{C23} in Formula (CT2) include linear or branched alkyl groups having from 1 to 10 carbon atoms (preferably from 1 to 6 carbon atoms and more preferably from 1 to 4 carbon atoms).

Specific examples of the linear alkyl groups include a methyl group, an ethyl group, an n-propyl group, an n-butyl group, an n-pentyl group, an n-hexyl group, an n-heptyl group, an n-octyl group, an n-nonyl group, and an n-decyl group.

Specific examples of the branched alkyl groups include an isopropyl group, an isobutyl group, a sec-butyl group, tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, a lower alkyl group such as a methyl group, an ethyl group, or an isopropyl group is preferable as the alkyl group.

Examples of the alkoxy group represented by R^{C21}, R^{C22}, and R^{C23} in Formula (CT2) include linear or branched alkoxy groups having from 1 to 10 carbon atoms (preferably from 1 to 6 carbon atoms and more preferably from 1 to 4 carbon atoms).

Specific examples of the linear alkoxy groups include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy groups include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group. The alkoxy group may be a methoxy group.

Examples of the aryl group represented by R^{C21}, R^{C22}, and R^{C23} in Formula (CT2) include aryl groups having from 6 to 10 carbon atoms (preferably from 6 to 9 carbon atoms and more preferably from 6 to 8 carbon atoms).

Specific examples of the aryl group include a phenyl group and a naphthyl group. The aryl group may be a phenyl group.

The substituents represented by RC²¹, R^{C22}, and R^{C23} in Formula (CT2) include those that have substituents. Examples of these substituents include atoms and groups (for example, a halogen atom, an alkyl group, an alkoxy group, an aryl group, etc.) described as examples above.

In order to form a photosensitive layer (charge transport layer) having a high charge transport capacity, R^{C21}, R^{C22}, and R^{C23} in Formula (CT2) may each independently represent a hydrogen atom or an alkyl group having from 1 to 10 carbon atoms. More preferably, R^{C21} and R^{C23} each represent a hydrogen atom and R^{C22} represents an alkyl group having from 1 to 10 carbon atoms (in particular, a methyl group).

Specifically, the compound represented by Formula (CT2) may be a charge transport material (Example Compound (CT2-2)) represented by Formula (CT2A) below:

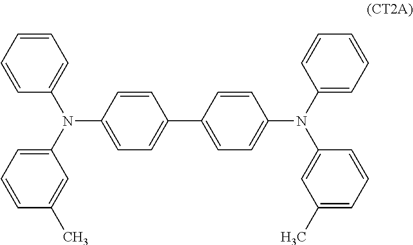 [SMILES: Cc1cccc(N(c2ccccc2)c2ccc(-c3ccc(N(c4ccccc4)c4cccc(C)c4)cc3)cc2)c1]

Non-limiting specific examples of the compound represented by Formula (CT2) are as follows:

### [Chem. 10]

| Example | | | |
|---|---|---|---|
| compound No. | R^{C21} | R^{C22} | R^{C23} |
| CT2-1 | H | H | H |
| CT2-2 | H | 3-CH₃ | H |
| CT2-3 | H | 4-CH₃ | H |
| CT2-4 | H | 3-C₂H₅ | H |
| CT2-5 | H | 4-C₂H₅ | H |
| CT2-6 | H | 3-OCH₃ | H |
| CT2-7 | H | 4-OCH₃ | H |
| CT2-8 | H | 3-OC₂H₅ | H |
| CT2-9 | H | 4-OC₂H₅ | H |
| CT2-10 | 3-CH₃ | 3-CH₃ | H |
| CT2-11 | 4-CH₃ | 4-CH₃ | H |
| CT2-12 | 3-C₂H₅ | 3-C₂H₅ | H |
| CT2-13 | 4-C₂H₅ | 4-C₂H₅ | H |
| CT2-14 | H | H | 2-CH₃ |
| CT2-15 | H | H | 3-CH₃ |
| CT2-16 | H | 3-CH₃ | 2-CH₃ |
| CT2-17 | H | 3-CH₃ | 3-CH₃ |
| CT2-18 | H | 4-CH₃ | 2-CH₃ |
| CT2-19 | H | 4-CH₃ | 3-CH₃ |
| CT2-20 | 3-CH₃ | 3-CH₃ | 2-CH₃ |
| CT2-21 | 3-CH₃ | 3-CH₃ | 3-CH₃ |
| CT2-22 | 4-CH₃ | 4-CH₃ | 2-CH₃ |
| CT2-23 | 4-CH₃ | 4-CH₃ | 3-CH₃ |

Abbreviations for the Examples Compounds are as follows and the number preceding a substituent indicates the substitution site with respect to a benzene ring:
—CH₃: methyl group
—C₂H₅: ethyl group
—OH₃: methoxy group
—OC₂H₅: ethoxy group

The compounds represented by Formula (CT2) may be used alone or in combination.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. The binder resin may be a polycarbonate resin or a polyarylate resin. These binder resins may be used alone or in combination.

The blend ratio of the charge transport material to the binder resin on a weight basis may be 10:1 to 1:5.

The charge transport layer 6 may contain a hindered phenol antioxidant. The hindered phenol antioxidant is a compound having a hindered phenol ring.

When the hindered phenol antioxidant is contained in the charge transport layer, positive ghosting and negative ghosting are more effectively suppressed. The reason why the positive ghosting and negative ghosting are more effectively suppressed when the hindered phenol antioxidant is contained in the charge transport layer is presumably the interaction, such as charge exchange, between the hindered phenol antioxidant and the short-lived trapping sites excited in the photosensitive layer by image exposure of the previous cycle, which eliminates the trapping sites.

The molecular weight of the hindered phenol may be 300 or more. As long as the hindered phenol antioxidant having a molecular weight of 300 or more is used, evaporation of the hindered phenol antioxidant in the drying step after the coating of the photosensitive layer is suppressed. Thus, it becomes possible to leave enough hindered phenol antioxidant in the photosensitive layer after drying needed for the function described above.

The hindered phenol antioxidant will now be described.

The hindered phenol antioxidant is a compound having a hindered phenol ring and having a molecular weight of 300 or more.

The hindered phenol ring of the hindered phenol antioxidant is, for example, a phenol ring substituted with at least one alkyl group having from 4 to 8 carbon atoms (for example, a branched alkyl group having from 4 to 8 carbon atoms). Specifically, the hindered phenol ring is a phenol ring in which a position ortho to a phenolic hydroxyl group is substituted with a tertiary alkyl group (for example, a tert-butyl group).

Examples of the hindered phenol antioxidant include the following:
1) an antioxidant having one hindered phenol ring;
2) an antioxidant having 2 or more and 4 or less hindered phenol rings that are linked to one another through a linking group that includes a linear or branched aliphatic hydrocarbon group having a valence of from 2 to 4 or through a linking group that includes an aliphatic hydrocarbon group having a valence of from 2 to 4 in which one or both of an ester bond (—C(═O)O—) and an ether bond (—O—) are inserted into a carbon-carbon-bond of the aliphatic hydrocarbon group; and
3) an antioxidant having 2 or more and 4 or less hindered phenol rings and one benzene ring (unsubstituted benzene ring or benzene ring substituted with alkyl or the like) or one isocyanurate ring, in which the 2 or more and 4 or less hindered phenol rings are linked through a benzene ring or an isocyanurate ring, and an alkylene group.

Specifically, an antioxidant represented by Formula (HP) may be used as the hindered phenol antioxidant from the viewpoint of suppressing burn-in ghosting and light-induced fatigue.

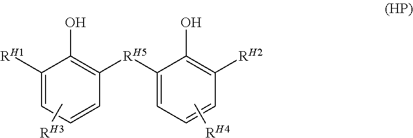

In Formula (HP), R^{H1}, and R^{H2} each independently represent a branched alkyl group having from 4 to 8 carbon atoms, R^{H3} and R^{H4} each independently represent a hydrogen atom or an alkyl group having from 1 to 10 carbon atoms, and R^{H5} represents an alkylene group having from 1 to 10 carbon atoms.

Examples of the alkyl group represented by R^{H1}, and R^{H2} in Formula (HP) include branched alkyl groups having from 4 to 8 carbon atoms (preferably from 4 to 6 carbon atoms).

Specific examples of the branched alkyl groups include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, and a tert-octyl group.

Among these, a tert-butyl group and a tert-pentyl group are preferable and a tert-butyl group is more preferable as the alkyl group.

Examples of R^{H3}, and R^{H4} in Formula (HP) include linear or branched alkyl groups having from 1 to 10 carbon atoms (preferably from 1 to 4 carbon atoms).

Specific examples of the linear alkyl groups include a methyl group, an ethyl group, an n-propyl group, an n-butyl group, an n-pentyl group, an n-hexyl group, an n-heptyl group, an n-octyl group, an n-nonyl group, and an n-decyl group.

Specific examples of the branched alkyl groups include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

The alkyl group may be a lower alkyl group such as a methyl group or an ethyl group.

R^{H5} in Formula (HP) represents a linear or branched alkylene group having from 1 to 10 carbon atoms (preferably from 1 to 4 carbon atoms).

Specific examples of the linear alkylene group include a methylene group, an ethylene group, an n-propylene group, an n-butylene group, an n-pentylene group, an n-hexylene group, an n-heptylene group, an n-octylene group, an n-nonylene group, and an n-decylene group.

Specific examples of the branched alkylene group include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, and a tert-decylene group.

Among these, lower alkylene groups such as a methylene group, an ethylene group, and a butylene group may be used as the alkylene group.

The substituents represented by R^{H1}, R^{H2}, R^{H3}, R^{H4,} and R^{H5} in Formula (HP) include those that have substituents. Examples of these substituents include a halogen atom (for example, a fluorine atom or a chlorine atom), an alkoxy group (for example, an alkoxy group having from 1 to 4 carbon atoms), and an aryl group (for example, a phenyl group or a naphthyl group).

From the viewpoint of suppressing burn-in ghosting and light-induced fatigue, R^{H1} and R^{H2} in Formula (HP) may each represent a tert-butyl group. Preferably, R^{H1}, and R^{H2} each represent a tert-butyl group, R^{H3} and R^{H4} each represent an alkyl group having from 1 to 3 carbon atoms (specifically, a methyl group), and R^{H5} represents an alkylene group having from 1 to 4 carbon atoms (specifically, a methylene group).

Specifically, the hindered phenol antioxidant may be a hindered phenol antioxidant represented by Example Compound (HP-3).

The molecular weight of the hindered phenol antioxidant may be 300 or more and 1000 or less, more preferably 300 or more and 900 or less, and yet more preferably 300 or more and 800 or less from the viewpoint of suppressing ghosting and light-induced fatigue.

Non-limiting specific examples of the hindered phenol antioxidant are as follows.

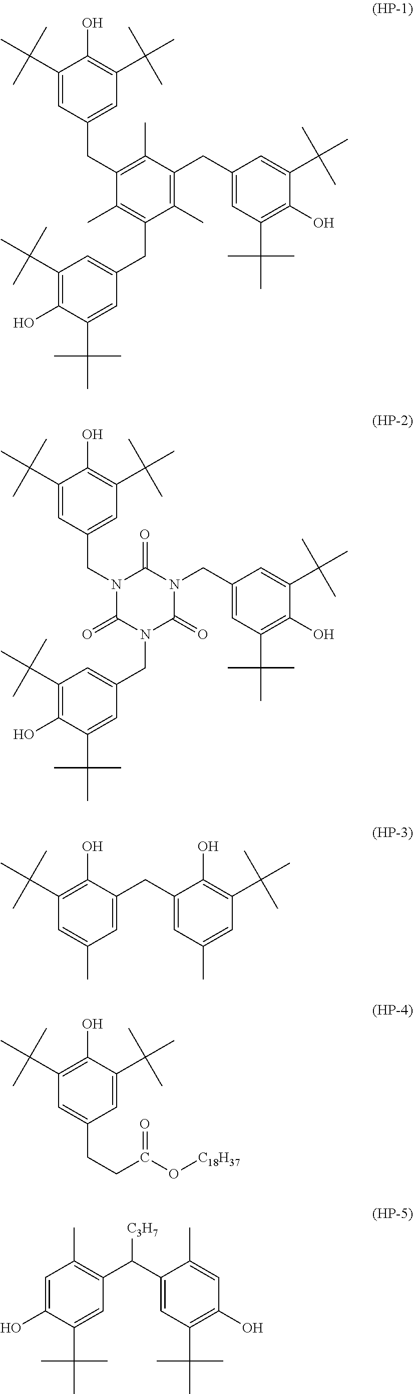

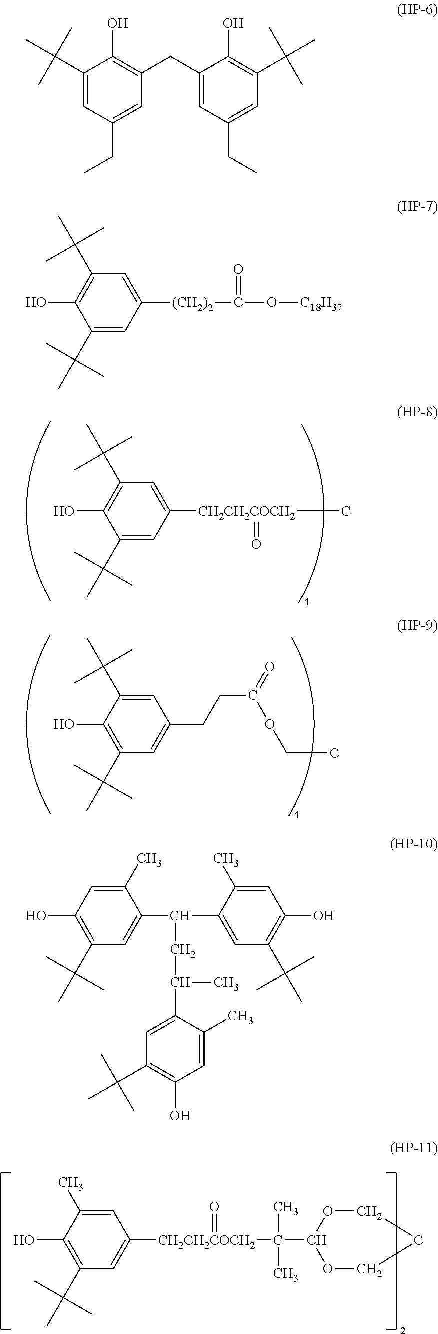

These hindered phenol antioxidants may be used alone or in combination.

The charge transport layer 6 is formed by applying the coating solution for forming the charge transport layer containing the materials described above to the charge generation layer 5 and drying the applied solution.

The solvent used in the coating solution may be any known organic solvent that can yield electrophotographic photoreceptor properties of the exemplary embodiment. For example, dioxane, tetrahydrofuran, methylene chloride, chloroform, chlorobenzene, or toluene may be used. These organic solvents may be used alone or in combination.

Examples of the method for applying the coating solution for forming the charge transport material to the charge generation layer include common methods such as a blade coating method, a wire bar coating method, a spray coating method, a dip coating method, a bead coating method, an air knife coating method, and a curtain coating method.

The charge transport layer 6 may have a thickness of 5 to 50 μm or 10 to 45 μm.

In order to improve smoothness and flatness of the coating film, a small amount of a silicone oil may be added as a leveling agent.

### Protective Layer

A protective layer is formed on the photosensitive layer if needed. The protective layer is formed to prevent chemical changes in the photosensitive layer during charging or further improve mechanical strength of the photosensitive layer.

In this respect, the protective layer may be a layer formed of a cured film (crosslinked film). Examples of such a layer include those described in 1) and 2) below.
1) a layer formed of a cured film prepared from a composition that contains a reactive-group-containing charge transport material that has a reactive group and a charge transport skeleton in the same molecule (in other words, a layer that contains a polymer or crosslinked product of the reactive-group-containing charge transport material); and
2) a layer formed of a cured film prepared from a composition that contains a non-reactive charge transport material and a reactive-group-containing non-charge transport material that contains no charge transport skeleton but a reactive group (in other words, a layer that contains a polymer or a crosslinked product of the non-reactive charge transport material and the reactive-group-containing non-charge transport material).

Examples of the reactive group of the reactive-group-containing charge transport material include known reactive groups such as a chain polymerizable group, an epoxy group, —OH, —OR [where R represents an alkyl group], —NH₂, —SH, —COOH, and —SiR^{Q1}_{3-Qn}(OR^{Q2})_{Qn} [where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group may be any functional group that is radically polymerizable. An example is a functional group having at least a carbon-carbon double bond. A specific example thereof is a group that contains at least one group selected from a vinyl group, a vinyl ether group, a vinyl thioether group, a styryl group, a vinylphenyl group, an acryloyl group, a methacryloyl group, and derivatives of the foregoing. The chain polymerizable group may be a group that contains, as the chain polymerizable group, at least one selected from a vinyl group, a styryl group, a vinylphenyl group, an acryloyl group, a methacryloyl group, and derivatives of the foregoing.

The charge transport skeleton of the reactive-group-containing charge transport material may be any known structure for electrophotographic photoreceptors. An example thereof is a structure having a skeleton derived from a nitrogen-containing hole transport compound such as a triarylamine compound, a benzidine compound, or a hydrazine compound, and being conjugated with a nitrogen atom. A triarylamine skeleton may be used as the skeleton.

The reactive-group-containing charge transport material that has a reactive group and a charge transport skeleton, the non-reactive charge transport material, and the reactive-group-containing non-charge transport material may be selected from known materials.

The protective layer may also contain known additives.

The protective layer may be formed by any known method. For example, the components described above may be added to a solvent to prepare a coating solution for forming a protective layer, the coating solution may be applied to form a film, and the film may be dried and, if needed, heated, to perform curing.

Examples of the solvent used to prepare the coating solution for forming a protective layer include aromatic solvents such as toluene and xylene; ketone solvents such as methyl ethyl ketone, methyl isobutyl ketone, and cyclohexanone; ester solvents such as ethyl acetate and butyl acetate; ether solvents such as tetrahydrofuran and dioxane; cellosolve solvents such as ethylene glycol monomethyl ether; and alcohol solvents such as isopropyl alcohol and butanol. These solvents may be used alone or in combination.

The coating solution for forming a protective layer may be a solvent-less coating solution.

Examples of the method for applying the coating solution for forming a protective layer to the photosensitive layer (for example, a charge transport layer) include common methods such as a dip coating method, a lift coating method, a wire bar coating method, a spray coating method, a blade coating method, a knife coating method, and a curtain coating method.

The thickness of the protective layer is, for example 1 μm or more and 20 μm or less or may be 2 μm or more and 10 μm or less.

### Single-Layer-Type Photosensitive Layer

The single-layer-type photosensitive layer (charge generation/charge transport layer) is a layer that contains, for example, a charge generation material, a charge transport material, and, if needed, a binder resin and other known additives. These materials are the same as those described in connection to the charge generation layer and the charge transport layer.

In the single-layer-type photosensitive layer, the charge generation material content relative to the total solid content is preferably 10% by weight or more and 85% by weight or less and more preferably 20% by weight or more and 50% by weight or less. In the single-layer-type photosensitive layer, the charge transport material content relative to the total solid content is preferably 5% by weight or more and 50% by weight or less.

The method for forming the single-layer-type photosensitive layer is the same as those for forming the charge generation layer and the charge transport layer.

The thickness of the single-layer-type photosensitive layer is, for example, 5 μm or more and 50 μm or less and may be 10 μm or more and 40 μm or less.

### Charging Device

Examples of the charging device 208 include contact-type chargers that use conductive or semiconductor charging rollers, charging brushes, charging films, charging rubber blades, charging tubes, etc. Alternatively, a known charger such as a non-contact-type roller charger, a scorotron charger or corotron charger that uses corona discharge, or the like may be used.

### Exposing Device

An example of the exposing device 210 is an optical device that illuminates the surface of the electrophotographic photoreceptor 207 by light from a semiconductor laser, an LED, or a liquid crystal shutter so as to form an intended light image on the surface. The wavelength of the light source is to be within the region of the spectral sensitivity of the electrophotographic photoreceptor. The mainstream semiconductor lasers are infrared lasers having an oscillation wavelength around 780 nm. The wavelength is not limited to this, and a laser that has an oscillation wavelength on the order of 600 nm or a blue laser that has an oscillation wavelength of 400 nm or more and 450 nm or less may also be used. A surface-emission type laser light source capable of outputting a multibeam is also effective for forming color images.

### Developing Device

An example of the developing device 211 is a common developing device that develops an image by using a developer in a contact or non-contact manner. The developing device 211 may be any device that has this function and may be freely selected according to the purpose. One example is a known developing device that has a function of causing a one-component developer or a two-component developer to adhere to the electrophotographic photoreceptor 207 by using a brush, a roller, or the like. In particular, the developing deice may use a development roller that retains a developer on its surface.

The developer used in the developing device 211 may be a one-component developer formed of a toner alone or may be a two-component developer formed of a toner and a carrier. The developer may be magnetic or non-magnetic. Known developers may be used.

### Cleaning Device

The cleaning device 213 is of a cleaning-blade type device equipped with a cleaning blade. Alternatively, a fur brush cleaning method or a simultaneous development and cleaning method may be employed instead of or in addition to the cleaning blade method.

### Transfer Device

Examples of the transfer device 212b include known transfer chargers such as contact-type transfer chargers that use belts, rollers, films, rubber blades, etc., and scorotron transfer chargers and corotron transfer chargers that use corona discharge.

### Intermediate Transfer Body

A semi-conductive belt-shaped member (intermediate transfer belt) formed of polyimide, polyamideimide, polycarbonate, polyarylate, polyester, rubber, or the like is used as the first transfer device 212a. Alternatively, the first transfer device 212a may have a drum shape.

### Image Forming Method

An image forming method includes a charging step of charging a surface of an electrophotographic photoreceptor that includes a photosensitive layer that contains a charge generation material, a charge transport material, and a binder resin; an electrostatic latent image forming step of forming an electrostatic latent image by exposing the charged surface of the electrophotographic photoreceptor; a developing step of developing the electrostatic latent image on the surface of the electrophotographic photoreceptor with a developer that contains a toner so as to form a toner image; and a transferring step of transferring the toner image onto a surface of a recording medium. A charge amount ΔQ(μC/m²), which is accumulated in the photosensitive layer by exposure conducted in the forming of the electrostatic latent image, per unit area of the surface of the electrophotographic photoreceptor, a charge potential VH(V) after the surface of the electrophotographic photoreceptor is charged in the charging of the surface of the electrophotographic photoreceptor, and an exposure potential VL(V) of a portion of the surface of the electrophotographic photoreceptor exposed in the forming of the electrostatic latent image satisfy Formula (1) described above.

A method for forming an image by using the image forming apparatus 200 of the exemplary embodiment illustrated in FIG. 2 is described as a specific example of the image forming method of the exemplary embodiment.

As the electrophotographic photoreceptor 207 is rotated, the surface of the electrophotographic photoreceptor 207 is, for example, negatively charged by using the charging device 208. The charging device 208 is electrically coupled to a controller (not shown) in the image forming apparatus 200. The charging device 208, to which a charge voltage is applied from the power supply 209, charges the surface of the photoreceptor 207 to a charge potential corresponding to the charge voltage applied. This means that the photoreceptor 207 is charged to the target charge potential (VH) by adjusting the charge voltage applied from the power supply 209.

The electrophotographic photoreceptor 207 having a negatively charged surface due to the contact-type charging device 208 is exposed by using the exposing device 210 to form an electrostatic latent image on the surface. The exposing device 210 is electrically coupled to a controller in the image forming apparatus 200 and applies to the charged surface of the electrophotographic photoreceptor 207 light L modulated based on image data of the image to be formed (exposure). Due to exposure, an electrostatic latent image corresponding to the image of the image data is formed on the surface of the electrophotographic photoreceptor 207. The exposed surface of the photoreceptor comes to have an exposure potential (VL) corresponding to the amount of light used in exposure.

As a portion of the electrophotographic photoreceptor 207 where the electrostatic latent image is formed approaches the developing device 211, the developing device 211 causes a toner to adhere to the electrostatic latent image and form a toner image.

The electrophotographic photoreceptor 207, now carrying the toner image, is further rotated, and the toner image is transferred to the first transfer device 212a (first transfer) and then to a recording sheet 500 through the second transfer device 212b. As a result, a toner image is formed on the recording sheet 500 (second transfer). After the first transfer, the residual toner on the electrophotographic photoreceptor 207 is removed by the cleaning device 213.

The recording sheet 500 with the toner image formed thereon goes through the fixing device 215 to have the toner image fixed. The fixing device 215 is not particularly limited and may be, for example, a hot roller fixing device or an oven fixing device. In FIG. 1, a hot roller fixing device equipped with a heating roll and a pressure roll opposing the heating roll is illustrated as an example.

The image forming apparatus of this exemplary embodiment may be equipped with a charge erasing unit. The charge erasing unit is, for example, disposed downstream of the cleaning device 213 in the electrophotographic photoreceptor 207 rotation direction and erases charges by exposing the surface of the electrophotographic photoreceptor 207 after the transfer of the toner image. Specifically, the charge erasing unit erases charges by exposing all parts of the surface of the electrophotographic photoreceptor 207 (all parts of the image forming region), for example.

An example of the charge erasing unit is a device equipped with a light source such as a tungsten lamp that emits white light or a light-emitting diode (LED) that emits red light.

The image forming apparatus 200 illustrated in FIG. 2 is configured to transfer the toner image formed on the surface of the photoreceptor 207 to the recording sheet 500 through first transfer and second transfer. Alternatively, the image forming apparatus of the exemplary embodiment may be configured to directly transfer the toner image on the surface of the photoreceptor 207 onto the recording sheet 500.

### EXAMPLES

Non-limiting examples of the exemplary embodiments will now be described. In the description below, “parts” and “%” are all on a weight basis unless otherwise noted.

### Example 1

### Preparation of Photoreceptor

### Photoreceptor 1

A mixture of 100 parts by weight of zinc oxide (trade name MZ 300, produced by Tayca Corporation), 10 parts by weight of a 10 wt. % toluene solution of N-2-(aminoethyl)-3-aminopropyltriethoxysilane serving as a silane coupling agent, and 200 parts by weight of toluene is prepared by mixing. The mixture is stirred and refluxed for 2 hours. Then toluene is distilled away at 10 mmHg and the surface is treated by conducting baking at 135° C. for 2 hours.

A mixture of 33 parts by weight of surface-treated zinc oxide, 6 parts by weight of blocked isocyanate (trade name: Sumidur 3175 produced by Sumitomo Bayer Urethane Co., Ltd.), 1 part by weight of a compound represented by formula (3) below, and 25 parts by weight of methyl ethyl ketone is mixed for 30 minutes, and then 5 parts by weight of a butyral resin (trade name: S-LEC BM-1 produced by Sekisui Chemical Co., Ltd.), 3 parts by weight of silicone balls (trade name: Tospearl 120 produced by Momentive Performance Materials Inc.), and 0.01 parts by weight of a silicone oil (trade name: SH29PA produced by Dow Corning Toray Silicone Co., Ltd.) serving as a leveling agent are added to the resulting mixture. The resulting mixture is dispersed for 3 hours in a sand mill. As a result, a dispersion (coating solution for forming an undercoat layer) is obtained.

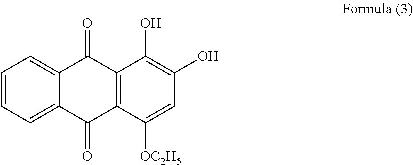 [SMILES: CCOc1cc(O)c(O)c2c1C(=O)c1ccccc1C2=O]

The coating solution is applied to an aluminum substrate having a diameter of 30 mm, a length of 365 mm, and a thickness of 1 mm by a dip coating method, and dried and cured at 180° C. for 30 minutes. As a result, an undercoat layer having a thickness of 25 μm is obtained.

A mixture containing a hydroxygallium phthalocyanine pigment, a vinyl chloride-vinyl acetate copolymer resin (trade name: VMCH, produced by Nippon Unicar Company Limited) serving as a binder resin, and n-butyl acetate is placed in a 100 mL glass jar together with glass beads 1.0 mm in diameter so that the charge ratio is 50%. The mixture is then dispersed for 2.5 hours by using a paint shaker to prepare a coating solution for forming a charge generation layer.

Relative to the mixture of the hydroxygallium phthalocyanine pigment and the vinyl chloride-vinyl acetate copolymer, the hydroxygallium phthalocyanine pigment content is set to 55.0% by volume. The solid content of the dispersion is set to 6.0% by weight. The content is calculated by assuming the specific gravity of the hydroxygallium phthalocyanine pigment to be 1.606 g/cm³, and the specific gravity of the vinyl chloride-vinyl acetate copolymer resin to be 1.35 g/cm³.

The obtained coating solution is applied to the undercoat layer by dipping and dried at 150° C. for 5 minutes. As a result, a charge generation layer having a thickness of 0.14 μm is formed.

A coating solution prepared by dissolving 12 parts by weight of a compound represented by Formula (CT1A) below, 28 parts by weight of a compound represented by Formula (CT2A) below, and 60 parts by weight of a bisphenol Z-type polycarbonate resin (molecular weight: 40,000) in 340 parts by weight of tetrahydrofuran is applied to the charge generation layer by dipping and dried at 150° C. for 40 minutes to form a charge transport layer having a thickness of 40 μm. As a result, a photoreceptor having an undercoat layer, a charge generation layer, and a charge transport layer sequentially stacked in that order is obtained. The thickness of each layer is measured with an eddy-current-type thickness meter (produced by Fischer Technology, Inc.).

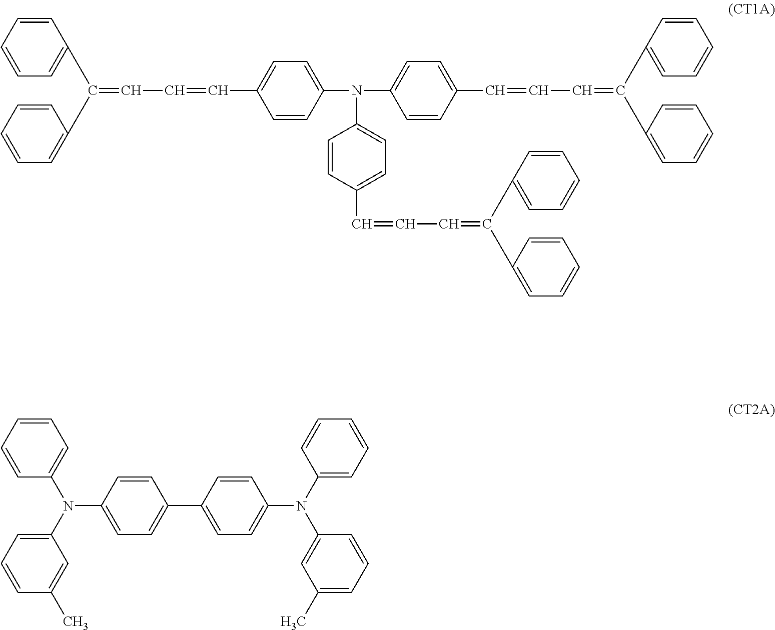 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1 ; Cc1cccc(N(c2ccccc2)c2ccc(-c3ccc(N(c4ccccc4)c4cccc(C)c4)cc3)cc2)c1]

The initial Q-V characteristic of the obtained photoreceptor is measured and Qleak1(μC/m²) in the initial state is determined.

Then the photoreceptor is loaded onto an apparatus equipped with a charging device, an exposing device, and a charge erasing device. A series of steps of charging, exposing, and charge removing is repeated for 800 cycles, the photoreceptor is left in a dark place for 15 minutes, and then the Q-V characteristic is measured again to determine the Qleak2(μC/m²) after exposure history. The conditions for repeating 800 cycles are as follows:
Charge potential: 700 (V)
Exposure light quantity: 10 (mJ/m²)
Exposure wavelength: 780 (nm)
Charge-erasing light source: halogen lamp (produced by Hayashi Watch Works Co. Ltd.)
Charge-erasing light wavelength: 600 nm or more and 800 nm or less
Charge-erasing light quantity: 30 (mJ/m²)
Rotational speed: 66.7 (rpm)

According to Formula (2) described above, ΔQ(μC/m²) is calculated from observed Qleak1(μC/m²) and Qleak2(μC/m²). The results are shown in Table.

Measurement of the Q-V characteristic and measurement of the surface potential of the photoreceptor regarding the charge potential VH(V) and the exposure potential VL(V) are conducted by using a surface potentiometer (Model 334 produced by Trek Japan Co., Ltd.) as follows.

The position of the charging device and the positions of the surface potentiometers used for measuring the charge potential VH(V), the exposure potential VL(V), and the Q-V characteristic are as follows with respect to the position of the charging device assumed to be 0 (ms).
Charging device: 0 (ms)
Position of installing surface potentiometer (P1) for measuring charge potential VH: 110 (ms)
Position of installing surface potentiometer (P2) for measuring exposure potential VL: 247 (ms)
Position of applying charge-erasing light: 635 (ms)
Position of installing potentiometer (P4) for measuring potential after charge erasing: 772 (ms)

The potential measured by P1 is used as the charge potential VH(V). The potential measured by P2 is used as the post-exposure potential VL(V). The potential obtained by subtracting the potential measured by P4 from the potential measured by P2 is used as the surface potential during the Q-V characteristic measurement. Q(μC/m²) during the Q-V characteristic measurement is obtained by calculating the charge amount per unit area (1 m²) of the photoreceptor from the amount of current flowing from the earth-side of the photoreceptor during charging. The amount of charges that have flown in per unit area of the photoreceptor is obtained by multiplying a charge width (m) of the charging device with a length (m) of one turn of the photoreceptor to calculate the charge area (m²) and dividing the flown-in charge amount (μC) by the charge area.

The obtained photoreceptor is loaded onto an image forming apparatus, which is a modified electrophotographic image forming apparatus (DocuCentre IV 5540 produced by Fuji Xerox Co., Ltd.) with which the charge potential VH(V) and the exposure potential VL(V) are freely adjustable. Then an image is output on a A3-size paper sheet.

The output image pattern includes a first cycle region (the region up to 94.2 mm from the leading edge) that corresponds to the first cycle of the photoreceptor and extends from the leading edge of the A3 paper sheet, and a second cycle region (the region 94.2 mm to 188.4 mm from the leading edge) that corresponds to the second cycle of the photoreceptor following the first cycle region. In the first cycle region, an all-white image with a 1 cm black solid square (density: 100%) at the center is formed. In the second cycle region, an all-halftone image (20% density, black) is formed. The ghost of the square image of the first cycle that appears in the halftone image is used for evaluation. The charge potential VH is 700 (V) and the exposure potential VL is 250 (V). The image is subjected to visual sensory evaluation (grade evaluation). The photoreceptor obtained is a negatively chargeable photoreceptor. Thus, the actual potential is of a negative polarity (VH=−700 (V), VL=−250 (V)).

The grade evaluation is done in 0.5 G increments from −5.0 to 5.0. The smaller the value, the better the result. A negative G value indicates negative ghosting and a positive G value indicates positive ghosting. The allowable range of the ghosting grade is −3.0 to 3.0.

The image is output in a 20° C., 40% RH environment. The results are shown in Table.

### Examples 2 to 16

Photoreceptors are prepared as in Example 1 except that the thickness of the charge generation layer of the electrophotographic photoreceptor, the charge potential VH, and the exposure potential VL are changed to the values indicated in Table. Evaluation is also conducted as in Example 1. The results are indicated in Table.

### Example 17

A photoreceptor is prepared as in Example 1 except that 3 parts by weight of a hindered phenol antioxidant represented by Formula (HP-3) is added to the coating solution for forming a charge transport layer. Evaluation is also conducted as in Example 1. The results are indicated in Table.

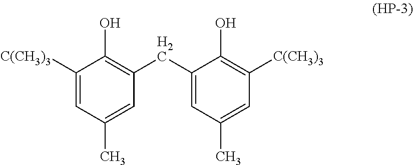 [SMILES: Cc1cc(Cc2cc(C)cc(C(C)(C)C)c2O)c(O)c(C(C)(C)C)c1]

### Examples 18 and 19

Photoreceptors are prepared as in Example 17 except that the amount of the hindered phenol antioxidant represented by Formula (HP-3) in the coating solution for forming a charge transport layer is changed to the value indicated in Table. Evaluation is also conducted as in Example 17. The results are indicated in Table.

### Example 20

A photoreceptor is prepared as in Example 1 except that the composition of the coating solution for forming a charge transport layer is changed to include 40 parts by weight of a compound represented by Formula (4) below, 60 parts by weight of a bisphenol-Z-type polycarbonate resin (molecular weight: 40,000), and 340 parts by weight of tetrahydrofuran. Evaluation is conducted as in Example 1. The results are indicated in Table.

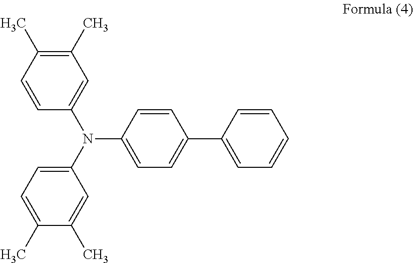 [SMILES: Cc1ccc(N(c2ccc(-c3ccccc3)cc2)c2ccc(C)c(C)c2)cc1C]

### Example 21

A photoreceptor is prepared as in Example 1 except that the composition of the coating solution for forming a charge transport layer is changed to include 40 parts by weight of a compound represented by formula (5) below, 60 parts by weight of a bisphenol-Z-type polycarbonate resin (molecular weight: 40,000), and 340 parts by weight of tetrahydrofuran. Evaluation is conducted as in Example 1. The results are indicated in Table.

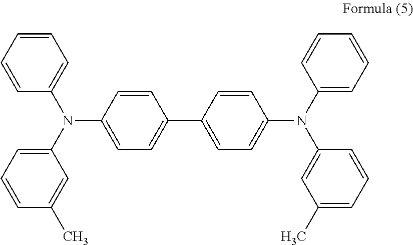 [SMILES: Cc1cccc(N(c2ccccc2)c2ccc(-c3ccc(N(c4ccccc4)c4cccc(C)c4)cc3)cc2)c1]

### Examples 22 and 23

Photoreceptors are prepared as in Example 1 except that the thickness of the charge generation layer of the electrophotographic photoreceptor and the amount of the hindered phenol antioxidant represented by Formula (HP-3) added are changed to values indicated in Table, respectively. Evaluation is conducted as in Example 1. The results are indicated in Table.

### Comparative Examples 1 to 5

Photoreceptors are formed as in Example 1 except that the thickness of the charge generation layer, the charge potential VH, and the exposure potential VL are changed to the values indicated in Table, respectively. Evaluation is conducted as in Example 1. The results are indicated in Table.

TABLE

| | | | | | Charge transport layer | | | | | | |
|---|---|---|---|---|---|---|---|---|---|---|---|
| | | | | | | | Amount of | | | | |
| | | | | | | | hindered- | | | | |
| | Charge | Exposure | Charge generation layer | | Amount of | | phenol-based | | | | Evaluation |
| | potential | potential | Charge | | charge transport | | antioxidant | | | (VH-VL)/ | of |
| | VH | VL | generation | Thickness | substance added | | added (parts | Thickness | ΔQleak | ΔQleak | ghosting |
| | (−V) | (−V) | substance | (μm) | (parts by weight) | | by weight) | (μm) | (μC/m²) | (V · m²/μC) | Grade |
| Example 1 | 700 | 250 | Hydroxygallium | 0.14 | CT1A | CT2A | 0 | 40 | 9.8 | 45.92 | 0 |
| | | | phthalocyanine | | (12) | (28) | | | | | |
| | | | pigment | | | | | | | | |
| Example 2 | 700 | 250 | Hydroxygallium | 0.15 | CT1A | CT2A | 0 | 40 | 10.5 | 42.86 | 0 |
| | | | phthalocyanine | | (12) | (28) | | | | | |
| | | | pigment | | | | | | | | |
| Example 3 | 700 | 250 | Hydroxygallium | 0.16 | CT1A | CT2A | 0 | 40 | 11.6 | 38.79 | 0.5 |
| | | | phthalocyanine | | (12) | (28) | | | | | |
| | | | pigment | | | | | | | | |
| Example 4 | 700 | 250 | Hydroxygallium | 0.17 | CT1A | CT2A | 0 | 40 | 12.3 | 36.59 | 1 |
| | | | phthalocyanine | | (12) | (28) | | | | | |
| | | | pigment | | | | | | | | |
| Example 5 | 700 | 250 | Hydroxygallium | 0.13 | CT1A | CT2A | 0 | 40 | 9.0 | 50.00 | −1 |
| | | | phthalocyanine | | (12) | (28) | | | | | |
| | | | pigment | | | | | | | | |
| Example 6 | 700 | 210 | Hydroxygallium | 0.13 | CT1A | CT2A | 0 | 40 | 9.0 | 54.44 | −2 |
| | | | phthalocyanine | | (12) | (28) | | | | | |
| | | | pigment | | | | | | | | |
| Example 7 | 700 | 200 | Hydroxygallium | 0.13 | CT1A | CT2A | 0 | 40 | 9.0 | 55.56 | −2.5 |
| | | | phthalocyanine | | (12) | (28) | | | | | |
| | | | pigment | | | | | | | | |
| Example 8 | 700 | 250 | Hydroxygallium | 0.18 | CT1A | CT2A | 0 | 40 | 14.8 | 30.41 | 2 |
| | | | phthalocyanine | | (12) | (28) | | | | | |
| | | | pigment | | | | | | | | |
| Example 9 | 700 | 250 | Hydroxygallium | 0.2 | CT1A | CT2A | 0 | 40 | 16.4 | 27.44 | 2 |
| | | | phthalocyanine | | (12) | (28) | | | | | |
| | | | pigment | | | | | | | | |
| Example 10 | 700 | 250 | Hydroxygallium | 0.19 | CT1A | CT2A | 0 | 40 | 13.6 | 33.09 | 1.5 |
| | | | phthalocyanine | | (12) | (28) | | | | | |
| | | | pigment | | | | | | | | |
| Example 11 | 700 | 200 | Hydroxygallium | 0.25 | CT1A | CT2A | 0 | 40 | 19.6 | 25.51 | 2 |
| | | | phthalocyanine | | (12) | (28) | | | | | |
| | | | pigment | | | | | | | | |
| Example 12 | 700 | 150 | Hydroxygallium | 0.25 | CT1A | CT2A | 0 | 40 | 19.6 | 28.06 | 2 |
| | | | phthalocyanine | | (12) | (28) | | | | | |
| | | | pigment | | | | | | | | |
| Example 13 | 700 | 250 | Hydroxygallium | 0.25 | CT1A | CT2A | 0 | 40 | 19.6 | 22.96 | 2.5 |
| | | | phthalocyanine | | (12) | (28) | | | | | |
| | | | pigment | | | | | | | | |
| Example 14 | 600 | 190 | Hydroxygallium | 0.25 | CT1A | CT2A | 0 | 40 | 19.6 | 20.92 | 3 |
| | | | phthalocyanine | | (12) | (28) | | | | | |
| | | | pigment | | | | | | | | |
| Example 15 | 580 | 100 | Hydroxygallium | 0.25 | CT1A | CT2A | 0 | 40 | 19.6 | 24.49 | 2.5 |
| | | | phthalocyanine | | (12) | (28) | | | | | |
| | | | pigment | | | | | | | | |
| Example 16 | 630 | 220 | Hydroxygallium | 0.11 | CT1A | CT2A | 0 | 40 | 6.9 | 59.42 | −3 |
| | | | phthalocyanine | | (12) | (28) | | | | | |
| | | | pigment | | | | | | | | |
| Example 17 | 700 | 250 | Hydroxygallium | 0.25 | CT1A | CT2A | 3 | 40 | 16.5 | 27.27 | 2 |
| | | | phthalocyanine | | (12) | (28) | | | | | |
| | | | pigment | | | | | | | | |
| Example 18 | 700 | 250 | Hydroxygallium | 0.25 | CT1A | CT2A | 3.5 | 40 | 14.7 | 30.61 | 1.5 |
| | | | phthalocyanine | | (12) | (28) | | | | | |
| | | | pigment | | | | | | | | |
| Example 19 | 700 | 250 | Hydroxygallium | 0.25 | CT1A | CT2A | 4 | 40 | 12.8 | 35.16 | 1 |
| | | | phthalocyanine | | (12) | (28) | | | | | |
| | | | pigment | | | | | | | | |
| Example 20 | 700 | 250 | Hydroxygallium | 0.14 | Formula (4) | | 0 | 40 | 17.0 | 26.47 | 2.5 |
| | | | phthalocyanine | | (40) | | | | | | |
| | | | pigment | | | | | | | | |
| Example 21 | 700 | 250 | Hydroxygallium | 0.14 | Formula (5) | | 0 | 40 | 18.0 | 25.00 | 2.5 |
| | | | phthalocyanine | | (40) | | | | | | |
| | | | pigment | | | | | | | | |
| Example 22 | 700 | 250 | Hydroxygallium | 0.27 | CT1A | CT2A | 0 | 40 | 19.0 | 23.68 | 2.5 |
| | | | phthalocyanine | | (12) | (28) | | | | | |
| | | | pigment | | | | | | | | |
| Example 23 | 700 | 250 | Hydroxygallium | 0.27 | CT1A | CT2A | 3 | 40 | 15.0 | 30.00 | 2.5 |
| | | | phthalocyanine | | (12) | (28) | | | | | |
| | | | pigment | | | | | | | | |
| Comparative | 700 | 250 | Hydroxygallium | 0.28 | CT1A | CT2A | 0 | 40 | 23.5 | 19.15 | 3.5 |
| Example 1 | | | phthalocyanine | | (12) | (28) | | | | | |
| | | | pigment | | | | | | | | |
| Comparative | 700 | 250 | Hydroxygallium | 0.29 | CT1A | CT2A | 0 | 40 | 25.9 | 17.37 | 4 |
| Example 2 | | | phthalocyanine | | (12) | (28) | | | | | |
| | | | pigment | | | | | | | | |
| Comparative | 700 | 250 | Hydroxygallium | 0.31 | CT1A | CT2A | 0 | 40 | 28.9 | 15.57 | 4.5 |
| Example 3 | | | phthalocyanine | | (12) | (28) | | | | | |
| | | | pigment | | | | | | | | |
| Comparative | 700 | 250 | Hydroxygallium | 0.34 | CT1A | CT2A | 0 | 40 | 31.5 | 14.29 | 5 |
| Example 4 | | | phthalocyanine | | (12) | (28) | | | | | |
| | | | pigment | | | | | | | | |
| Comparative | 630 | 220 | Hydroxygallium | 0.09 | CT1A | CT2A | 0 | 40 | 6.7 | 61.19 | −3.5 |
| Example 5 | | | phthalocyanine | | (12) | (28) | | | | | |
| | | | pigment | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an electrophotographic photoreceptor that includes a photosensitive layer that contains a charge generation material, a charge transport material, and a binder resin;
a charging unit that charges a surface of the electrophotographic photoreceptor;
an electrostatic latent image forming unit that forms an electrostatic latent image by exposing the charged surface of the electrophotographic photoreceptor;
a developing unit that develops the electrostatic latent image on the surface of the electrophotographic photoreceptor with a developer that contains a toner so as to form a toner image; and
a transfer unit that transfers the toner image onto a surface of a recording medium,
wherein a charge amount ΔQ(μC/m²), which is accumulated in the photosensitive layer by exposure conducted by using the electrostatic latent image forming unit, per unit area of the surface of the electrophotographic photoreceptor, a charge potential VH(V) after the surface of the electrophotographic photoreceptor is charged by using the charging unit, and an exposure potential VL(V) of a portion of the surface of the electrophotographic photoreceptor exposed by using the electrostatic latent image forming unit satisfy Formula (1):
20(V·m²/μC)≦[VH−VL](V)/ΔQ(μC/m²)≦60(V·m²/μC) Formula (1)

2. The image forming apparatus according to claim 1, wherein [VH−VL](V)/ΔQ(μC/m²) is 25(V·m²/μC) or more and 55(V·m²/μC) or less.

3. The image forming apparatus according to claim 1, wherein [VH−VL](V)/ΔQ(μC/m²) is 35(V·m²/μC) or more and 50(V·m²/μC) or less.

4. The image forming apparatus according to claim 1, wherein the charge transport material contained in the photosensitive layer includes a compound represented by Formula (CT1) below and a compound represented by Formula (CT2) below: 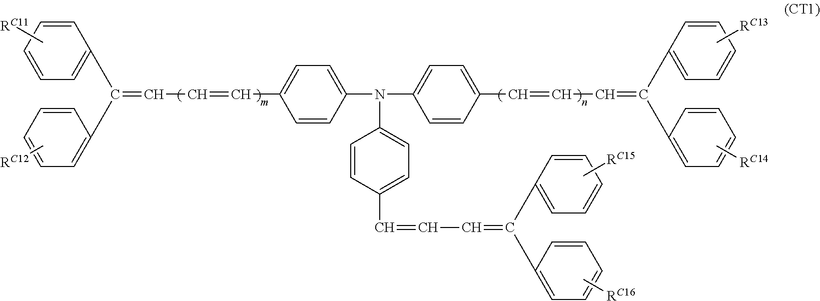
(In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms; adjacent two substituents may bond to each other to form a hydrocarbon ring structure; and n and m each independently represent 0, 1, or 2.); 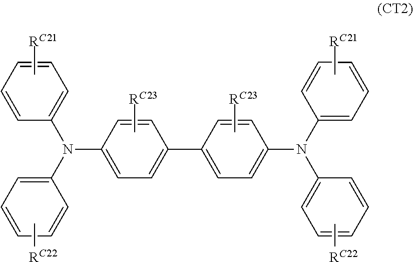
(In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.)

5. The image forming apparatus according to claim 1, wherein the charge generation material contained in the photosensitive layer includes hydroxygallium phthalocyanine.

6. The image forming apparatus according to claim 1, wherein the photosensitive layer includes a charge generation layer that contains hydroxygallium phthalocyanine as the charge generation material and a charge transport layer that contains a compound represented by Formula (CT1) below and a compound represented by Formula (CT2) below as the charge transport material: 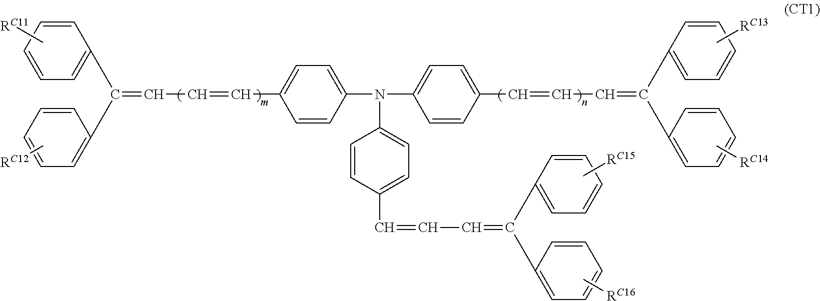
(In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms; adjacent two substituents may bond to each other to form a hydrocarbon ring structure; and n and m each independently represent 0, 1, or 2.); 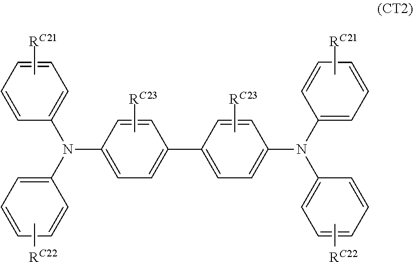
(In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.)

7. The image forming apparatus according to claim 1, wherein the photosensitive layer contains a hindered phenol antioxidant.

8. An image forming method comprising:
charging a surface of an electrophotographic photoreceptor that includes a photosensitive layer that contains a charge generation material, a charge transport material, and a binder resin;
forming an electrostatic latent image by exposing the charged surface of the electrophotographic photoreceptor;
developing the electrostatic latent image on the surface of the electrophotographic photoreceptor with a developer that contains a toner so as to form a toner image; and
transferring the toner image onto a surface of a recording medium,
wherein a charge amount ΔQ(μC/m²), which is accumulated in the photosensitive layer by exposure conducted in the forming of the electrostatic latent image, per unit area of the surface of the electrophotographic photoreceptor, a charge potential VH(V) after the surface of the electrophotographic photoreceptor is charged in the charging of the surface of the electrophotographic photoreceptor, and an exposure potential VL(V) of a portion of the surface of the electrophotographic photoreceptor exposed in the forming of the electrostatic latent image satisfy Formula (1):
20(V·m²/μC)≦[VH−VL](V)/ΔQ(μC/m²)≦60(V·m²/μC) Formula (1)

9. The image forming method according to claim 8, wherein [VH−VL](V)/ΔQ(μC/m²) is 25(V·m²/μC) or more and 55(V·m²/μC) or less.

10. The image forming method according to claim 8, wherein [VH−VL](V)/ΔQ(μC/m²) is 35(V·m²/μC) or more and 50(V·m²/μC) or less.

11. The image forming method according to claim 8, wherein the charge transport material contained in the photosensitive layer includes a compound represented by Formula (CT1) below and a compound represented by Formula (CT2) below: 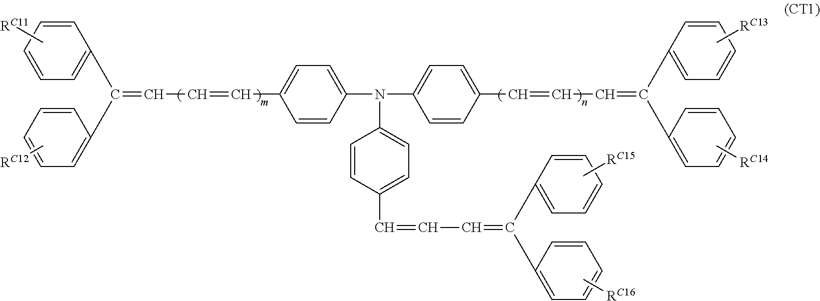
(In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms; adjacent two substituents may bond to each other to form a hydrocarbon ring structure; and n and m each independently represent 0, 1, or 2.); 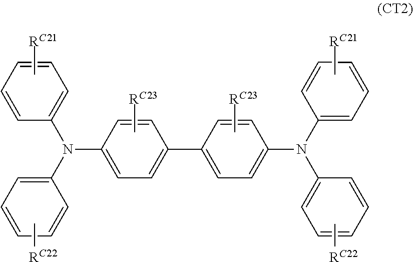
(In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.)

12. The image forming method according to claim 8, wherein the charge generation material contained in the photosensitive layer includes hydroxygallium phthalocyanine.

13. The image forming method according to claim 8, wherein the photosensitive layer includes a charge generation layer that contains hydroxygallium phthalocyanine as the charge generation material and a charge transport layer that contains a compound represented by Formula (CT1) below and a compound represented by Formula (CT2) below as the charge transport material: 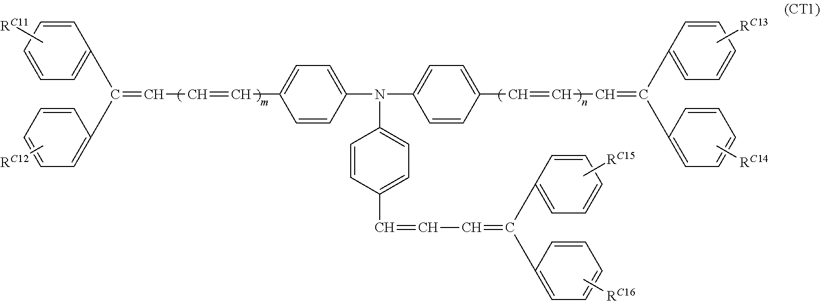
(In Formula (CT1), R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms; adjacent two substituents may bond to each other to form a hydrocarbon ring structure; and n and m each independently represent 0, 1, or 2.); 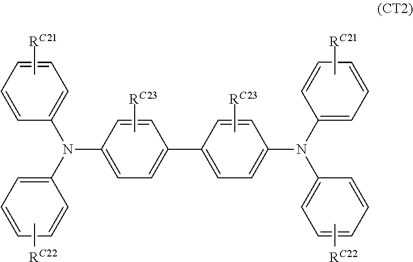
(In Formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.)

14. The image forming method according to claim 8, wherein the photosensitive layer contains a hindered phenol antioxidant.
